(19) United States
(12) Patent Application Publication
(10) Pub. No.: US 2015/0234952 A1
(43) Pub. Date: Aug. 20, 2015

(54) SYSTEM AND METHOD FOR SIMULATING OPERATION OF A NON-MEDICAL TOOL

(71) Applicant: SATA GMBH & CO. KG, Kornwestheim (DE)

(72) Inventors: Albrecht Kruse, Stuttgart (DE); Holger Essig, Benningen (DE); Christian Hagenah, Ainring (DE)

(21) Appl. No.: 14/426,438

(22) PCT Filed: Jun. 18, 2013
(86) PCT No.: PCT/EP2013/062643

§ 371 Date: Mar. 6, 2015

(30) Foreign Application Priority Data
Sep. 7, 2012 (DE) 10 2012 017 700.3

(51) Int. Cl. G06F 17/50

(52) U.S. Cl. CPC G06F 17/5009

(57) ABSTRACT

A system and method for simulating operation of a non-medical tool, having at least one device for detecting the spatial position and movement of a user, a data processing device and at least one display device that displays a virtual processing object. The data of the device for detecting the spatial position and movement of a user are sent to the data processing device, are processed there, and are forwarded to the at least one display device which displays an image of the user or of a part of the user and an image of the tool, the positions and movements of the images being displayed on the basis of the data of the devices for detecting the spatial position and movement of a user relative to the virtual processing object.

The invention concerns a system for simulating the operation of a nonmedical tool according to the preamble of claim 1 and a method for simulating the operation of a nonmedical tool according to the preamble of claim 53.

Most of the time, the operation of tools requires a certain amount of practice, because many tools reveal their full capacity only with proper operation or use. Frequently, a very precise sequence of motions is needed for this purpose. For example, when using saws, one must pay close attention to holding the saw in a vertical position in order to prevent a jamming or bending of the saw. When using hammers and axes, a high degree of accuracy is needed. Frequently, a wrong use carries high risks for the well-being of the user, as, for example, when using chainsaws, axes, angle grinders or other tools. This danger exists, above all, if an inexperienced user wants to operate to tool for practice. Such a first use is carried out, as a rule, in the presence of an experienced supervising person, who often cannot react fast enough, however, so as to prevent an accident.

However, even with less dangerous tools, disadvantages arise when they are being used for practice. In the area of painting surfaces with spray paint guns, for example, it is desirable that the least possible paint, cleaning agent, and objects for test coating be used in the training of painters to keep costs down and to protect the environment. Thus, the training of painters is carried out in a traditional manner by the actual painting of different objects, wherein coatings for training purposes are carried out several times. The disadvantage here is that a lot of paint or varnish and cleaning agent are thereby consumed and the objects to be painted become useless after having been used several times, so that they must be disposed of.

Also, it is often desirable to obtain a sample of the object that is to be produced or processed with the aid of the tool. In coating technology, it is desirable to be able to test various coatings quickly, simply, and as realistically as possible when producing color samples and design proposals. In this respect, and in accordance with the state of the art, there are two possibilities—namely, the production of real test coatings or the simulation of the coating with computer-aided painting and drawing software.

The traditional way of producing test coatings consists of applying the desired coatings with a real spray paint gun on the surfaces of real objects to be coated, wherein, of course, the original appearance of the various coatings is to be attained. The disadvantage hereby is that a sample must be produced for each coating in order to be able to compare the various coatings to one another. In particular, with large and expensive objects to be coated, this is wasteful with regard to production technology and costs. Also, the preparation of the coating itself is time-consuming and costly, since the surfaces of the objects to be coated must first be prepared for the coating and, after each coating, the varnish or the paint must first dry. Errors during the coating cannot be corrected or can be corrected only with difficulty. Moreover, with these sample coatings, paints, lacquers and cleaning substances harmful to the environment are consumed. The coated objects are destroyed after the selection of the desired coating, while if they are to be used further, they are cleaned, with a removal of the applied coats, using cleaning substances that harm the environment and are unhealthy.

In an alternative possibility, the desired paint-sprayed coating can be simulated with computer-aided painting and drawing software on a traditional data processing device. In this respect, the simulation of the paint or varnish application with normal computer input devices, for example, a computer mouse or computer drawing pens, takes place; the display is carried out on a screen of the data processing device. The colors and shapes of the paint or varnish application are adjusted in accordance with the software on the painting and drawing program so that the visual display of the coating is as close as possible to the result of a coating application with a spray paint gun activated manually. The disadvantage with this computer-aided simulation of the manual coating application is that with the traditional computer input devices, the handling and the operation of a real spray paint gun can be simulated only insufficiently, so that the simulation of the coating, displayed on the screen, can simulate the effects attained in a real application with a real spray paint gun only insufficiently. Some effects cannot be simulated at all in this manner—for example, an approaching or moving away of the spray paint gun from the surface to be coated.

To avoid these problems in the area of coating technology, DE 20 2005 001 702 U1 therefore proposes a virtual coating system, which has a virtual coating device, a position detector to detect the spatial position of the coating device relative to the coating surface, a data processing unit, and a display device, wherein the position data of the coating device are sent to the data processing unit and there are converted into image data that visualize the virtual coating and that are sent on to the display device so as to display a visual image of the virtual coating process on the coating surface. In this way, a virtual coating is virtually depicted in a realistic manner and in real time.

The disadvantage in this solution, however, is that the user sees only the display of a white surface on which the coating is to be applied. The variation possibilities are very slight in this solution, and for this reason, the motivation of the person who is practicing quickly dwindles.

The goal of the invention under consideration, therefore, is to create a system for the simulation of the operation of a nonmedical tool, which offers an extended representation and a greater versatile training routine.

This goal is attained in accordance with the invention with a system for the simulation of the operation of a nonmedical tool with the features of claim 1 and a method for the simulation of the operation of a nonmedical tool with the features of claim 53. Advantageous developments are the object of the subclaims.

The system in accordance with the invention has a device for the detection of the spatial position and the movement of a user, a data processing device, and at least one display device, which displays a virtual processing object, wherein the data of the device for the detection of the spatial position and movement of a user are sent to the data processing device; they are processed there and sent on to the at least one display device, which displays an image of the user or a part of the user and an image of the tool, and wherein the position and the movements of the images are displayed on the basis of the data of the device for the detection of the spatial position and the movement of the user, relative to the virtual processing object.

By means of these developments, not only can a white surface be seen on the display device, as in the state of the art, but at least also a user or a part of the user and the tool. The detected data are sent to a data processing device, processed, converted, for example, into image data, and sent on to at least one display device. Preferably, the data processing device is designed as a computer, in particular as a PC. In this way, the hardware needed for the system in accordance with the invention can be reduced to a few individual parts. Ideally, the system can be connected to any arbitrary PC that has the necessary software. However, it is conceivable that the system in accordance with the invention is also compatible with other computers, in particular with tablet PCs or other mobile data processing devices. The object to be processed does not completely fill the display device, but rather is a unit that is depicted far from the observer. In front, there is an image of the user or a part of the user, such as an arm, and an image of the tool. If the system in accordance with the invention has a camera, then the photographs obtained with it can be depicted as images. The images, however, can also be animations. It is also possible to depict an image as an animation and as an image other than a photograph. The data of the device for the detection of the spatial positions and movements of the user are processed by common visualization methods for the generation of a 3-D model and conducted to the display device. The images shown by the display device move, in real time, in accordance with the movements of the user and the tool, which are detected by the devices for the detection of the positions and movements. If the user of the system in accordance with the invention moves his arm, for example, to the left, the displayed image of the arm is simultaneously, or almost simultaneously, likewise moved to the left. Depending on how large the image excerpt shown by the display device is, the whole user can be represented, or only a part. Preferably, at least the arm of the user whose hand operates the tool is depicted. Not only movements of the limbs of the user can be detected, but rather, optionally, facial movements also—that is, his facial expressions. The whole user need not be detected, but rather the detection of the position and movements can also be limited to one part of the user.

Preferably, the system has a device for the detection of the spatial position and movement of the tool operated by the user. With particular preference, the position and the movement of the user are detected with a device other than the one detecting the position and the movement of the tool. In this way, a higher accuracy can be attained in the detection of the tool. The position of the tool is preferably determined as accurately as possible, as with the position of the user, so that the situation may be such that the detected position of the arm and the hand of the user does not match the detected position of the tool. Thus, for example, the arm of the image of the user would actually be too far left and thus next to the tool. Therefore, the image of the user is preferably staggered in such a manner that it fits with the position of the tool. Advantageously, the alignment of the tool can also be detected with the detection device—that is, if the tool is held at an incline. The tool operated by the user of the system in accordance with the invention can be a real example of a tool or also a model with the same or similar form but without function. However, it can also thereby be a controller, which is shaped as a simple rectangular solid or in some other way, or has approximately the shape of the tool.

Preferably, the system in accordance with the invention has a device for the detection of the operation of the tool that is connected to the data processing device. The system can thus detect if the tool is activated, and to what extent. This is, above all, relevant with those tools that have a trigger, such as a drilling machine, an angle grinder, or a spray paint gun. A device to detect the spatial position and movement of the tool cannot detect whether such tools are activated, as a rule, since there is no extended movement when they are activated. To what extent the trigger is activated is also detected—that is, to what extent, for example, a button has been pressed down or to what extent a trigger lever is moved. The trigger can be the actual trigger when using a real example of the tool, otherwise a switch, lever, button, trigger guard, or something else functions as the trigger. A pressure sensor, for example, can be used as the device to detect the movement of the tool; it can be located behind or on the trigger of the tool and can detect an operation and the intensity of the operation of the trigger. However, other sensors can also be used, which can be connected with the electrical or electronic system of the tool, which plays a role for the activation of the tool.

With particular preference, the at least one display device displays the image of the tool in the activated state with the operation of the tool. The device to detect the operation of the tool reports the operation and the intensity of that operation to the data processing device, whereupon it transmits to the display device the image data prepared for the purpose for the tool in the activated state. With a drilling machine, for example, this results in a drill chuck rotating with a drill insert; with an angle grinder, in a rotating separation disk; and with a spray paint gun, in a spray jet or a paint mist exiting from the gun, and always taking into consideration the intensity of the operation.

Preferably, an operation of the tool, depending on its position and movement, produces a change on the virtual processing object. If the image of an activated drilling machine or an activated angle grinder is so far removed from the processing object that the rotating components do not have any contact with the processing object, then the processing object does not change. If the user of the system in accordance with the invention moves the tool in such a way that the image of the tool is moved so far toward the processing object that the decisive components come into contact with the processing object, then a change is displayed on the processing object. For various contact points between the tool and the processing object, various image data are displayed on the data processing device or a storage unit connected with it. In case of contact, the suitable image is conducted to the display device and is displayed by this device simultaneously or almost simultaneously with the contact-producing movement of the user. If additional movements of the tool are carried out, additional changes can appear, depending on the direction of movement. If, for example, a drilling machine or an angle grinder is moved in such a way that its image appears in contact with the virtual processing object, then what is first detected is that the tool is a unit far immersed in the processing object. If the tool would then be moved in the opposite direction, then a round trough or a longish groove would be seen on the processing object. However, if the tool is further moved in the direction of the processing object, then the tool is immersed deeper into the object, and the trough becomes a drilling hole and the groove becomes longer and deeper. If an activated spray paint gun is held in such a way that the image is shown in the direction of the virtual processing object, the processing object is depicted as provided with paint, varnish, or another spray medium. If the spray paint gun is far removed from the object, then paint droplets are depicted as lying less densely next to one another than when the object is sprayed from a shorter distance. If the spray paint gun is held at an incline to the object, then the object is impinged on with more paint in one area than in the opposite area. With particular preference, with an excess application of paint, the paint is depicted running off on the object. With the aforementioned tools, as well as with other tools, the change on the virtual processing object takes place as with a real use of the tool on a real object.

The system in accordance with the invention can be designed in such a way that the simulation is interrupted or blocked, if, under real conditions, an injury of the user or another person would take place. For example, that may be the case if the user points the spray paint gun at himself or at another living being, reaches into the activated drilling tool or the activated angle grinder, or in some other manner brings a body part into the action range of a tool, or points the tool at other persons. A warning sign and an acoustic signal can be emitted—at least a display device can blink red, semi-transparently, or some other display can be shown that there is danger.

The system in accordance with the invention can preferably have a device to produce resistance against the movement of the tool. If the user moves the tool, then it gets to a point at which the movement cannot be continued in an unhindered manner. This may logically be the point at which the image of the tool comes into contact with the virtual processing object. The device to produce the resistance can be, for example, a rope, a cord, a wire, or something else that can be affixed on one side of the tool and, on the other side, on the ceiling, the floor, or a wall. The device can have at least one spring which, although it still allows a movement of the tool if the rope, the cord, the wire is already tight, nevertheless makes the movement difficult. Thus, for example, the penetration of an angle grinder into a processing object can be simulated even more realistically. The device to produce resistance can, however, also be a real object that is found in the same position relative to the user as the virtual processing object is, relative to the image of the user. The object can preferably be deformed plastically or elastically, wherein the force needed for the deformation corresponds to the force that is needed for the process of a real processing object with a real tool. The device to produce resistance creates the same resistance as a real processing object during the processing by a real tool, for example, the resistance that an object offers an angle grinder. In order to place the virtual processing object into the same position relative to the image of the user as the object for producing resistance is relative to the user of the system in accordance with the invention, a device to detect the position of the object for producing resistance can be provided.

In a preferred embodiment example of the system in accordance with the invention, the device to detect the spatial position and movement of the user has at least one illuminating unit and at least one sensor. The illuminating unit emits a light pulse, which is reflected by the user and is captured by the sensor. The time required by the light pulse from the illuminating unit to the user and from there to the sensor is measured for each light point. From this time, the distance of the user from the device to detect the spatial position and movement is calculated. Since the user is a three-dimensional object, various points of the user are at different distances from the device, and for this reason the light points need different times from the illuminating unit to the object and back again. From the different times, different distances are calculated, wherein a three-dimensional image is prepared and distances can be detected. Also, movements in three-dimensional space can be detected in this way. However, it is also possible for the illuminating unit to emit several light points or lines whose structure is deformed on a three-dimensional object and wherein the sensor can detect these deformations and depth information can be calculated. Also, the light from the illuminating unit striking the object can be detected by devices that detect the object and thus the light striking thereon from various perspectives. Also from this, 3-D information and/or distances can be derived. With particular preference, the illuminating unit is an infrared radiator and the sensor is an infrared sensor. The advantage to this is that infrared rays are invisible to the human eye. The device to detect the spatial position and the movement of the user can also have active and passive markers affixed to the user. Via cameras, the markers are detected and the spatial position of the markers and thus of the user can be determined by a triangulation method. The device to detect the spatial position and movement of the user, however, can also be designed in some other manner, for example, as an electromagnetic, acoustic, or another optical system. Also, an accelerometry method can be alternatively or additionally used, that is, acceleration sensors can be affixed to the user, whose data are evaluated in order to detect movement.

With particular preference, the device to detect the spatial position and the movement of the user is designed as a depth camera (TOF, Time-of-Flight, 3-D camera). This preferably has, among other things, an illuminating unit, two sensors, a color camera, and a data processing unit, wherein the illuminating unit is preferably an infrared radiator and the two sensors are infrared sensors. The illuminating unit can emit structured light, for example, in the form of grid lines or stripes. These structures are deformed by three-dimensional objects. The deformations can be captured by the sensors and/or the color camera and can be converted into distances and/or 3-D information by the data processing unit. This allows a detection of the spatial position of the user and the detection of a movement in three-dimensional space.

In a particularly preferred embodiment example of the system in accordance with the invention, the device to detect the spatial position and the movement of the tool has at least one radio transmitter and at least one radio receiver. The radio transmitter, preferably located on the tool, emits radio signals that are received by the stationary radio receiver, which is preferably located in the vicinity of the tool. From the transit time of the signals, it is possible to calculate the position of the transmitter and thus the position of the tool on which the transmitter is located. Preferably, at least four radio receivers are positioned in the vicinity of the tool, wherein the accuracy of the system can be increased. Alternatively, the radio receiver can also be located on the tool and the radio transmitter(s), in the vicinity.

A radio system has a higher accuracy than optical methods with an illuminating unit and sensors. Frequently, when using a tool, this accuracy is very important, so that a greater accuracy in the position and movement detection with the tool further increases the training effect. When detecting the user, the described optical methods are sufficient, since his exact position has less influence on the work result. At the same time, the use of optical methods is less expensive, since only one single device is needed on one single site, which can remain unchanged at its position, even if various users successively use the system. One part of the radio system, either the transmitter or the receiver, would have to be transferred, with each change of the user, from the old to the new user and be affixed to him. Since the tool, as a rule, remains the same, such a change is dispensed with in the detection of the position and the movement of the tool. If the position and the movement of the user, however, are to be detected precisely, then, of course, it is also conceivable to equip him with the radio receiver or transmitter and to position the corresponding counter component in the vicinity. The radio system can be operated both with batteries or rechargeable batteries, and also by means of the so-called Energy Harvesting—that is, to obtain their energy from light, temperature, air movement or pressure. Other systems can also be used for the detection of the position and the movement of the tool and also for the detection of the position and the movement of the user, such as light barriers, potentiometers, inductive methods, reverb methods, magnetoresistive or magnetoinductive methods, other optical methods, or something else.

Preferably, the tool has at least one sensor, which, for example, can be designed as a slope sensor or a gravity sensor, an acceleration sensor or an angle sensor. By this means, the accuracy of the position and movement detection of the tool can be further improved. The alignment of the tool, the slope, or something else can also be detected. This means that if the user holds the tool at an incline or in a specific direction, that direction is also detected by means of the sensor, whereupon the image of the tool assumes a corresponding alignment. The image of the arm of the user follows this alignment. Also, with the aid of the sensors, not only translational movements of the tool can be detected, but also rotational movements. This is particularly important with tools in which the operating movement has a high rotational fraction, for example, with screwdrivers. Also, by means of a detection of the alignment of the tool, it is possible to detect whether the user has suitably aligned the tool with respect to the processing object. For example, it can be detected when the user of a drilling machine is not holding it at a right angle to the processing object. The training effect can be greatly increased in this manner or it can even be set up for the first time. When using spray paint guns, the alignment of the gun relative to the processing object has a decisive influence on the coating result. If the gun is not held at a right angle to the object, the paint mist exiting from the gun has a smaller distance to the object on one side than on the opposite side. There is an excessive paint application on the side with a shorter distance and thus a nonuniform coating, and there will be paint flowing down from the object. One or more sensors can also be provided, both a combination of similar as well as different sensors.

Preferably, at least one device to detect the spatial position and the movement of a body part of a user is provided in the system in accordance with the invention. This can be an additional device, which exists in addition to the devices for the user as a whole and the tool, or it can be one of these two systems, which has an additional focus on a body part of the user. Additionally or alternatively, slope sensors or gravity sensors, acceleration sensors, or angle sensors can also be provided so as to be better able to detect slopes and alignments of the body part. The aforementioned body part of the user can be, for example, his head, wherein both swivel movements, that is, up or down movements, movements to the left, right, or at an incline, as well as rotating movements, can be detected.

With particular preference, the device to detect the spatial position and the movement of a body part of a user is another radio transmitter or receiver that communicates with a corresponding counter component in the vicinity. A radio system is advantageous, since head movements, as a rule, are not particularly extensive, and for that reason, an accurate system is needed so as to be able to detect smaller movements also. Other techniques, however, are also conceivable, for example, those mentioned above. It is thus possible to allow the head of the image of the user, which is displayed by at least one display device, to move simultaneously or almost simultaneously with the real head movements of the user.

Preferably, the display of at least one display device is changed as a result of the position and the movement of the head of the user. For example, with a movement of the head to the left, the head of the image of the user shown on the display device can likewise move to the left. The image section shown can shift to the left. The same is true for other movement directions that bring about a movement of the head and/or a shift of the image section in the corresponding direction. A display device can represent an ego perspective, which is also designated as an I perspective, First Person View, or First Person Perspective (FPP)—that is, the field of view of the user is displayed—in the case under consideration, that which the virtual image of the user sees. Here, a movement of the head of the user likewise causes a shift of the image section shown on the display device, corresponding to the circumstance in reality.

In a preferred embodiment example of the system in accordance with the invention, at least one device for gaze detection is provided. Such a system is also designated as eye tracking and it permits the detection of the eye or gaze movements of a person—in the case under consideration, those of the user. It can thereby be a mobile system that is affixed to the head of the user as well as an externally installed system. The former essentially consists of an eye camera and a field of vision camera. By a combination of the photographs, it is possible to determine which point in the field of vision of the carrier of the system is being observed at the moment. In the case under consideration, the real eye of the user and the image of the virtual vicinity that the user is viewing at the moment are detected. With particular preference, the display of at least one display device changes as a result of the gaze direction of the user. For example, the point in the field of vision of the user on which his gaze is directed at the moment can be centered simultaneously or almost simultaneously in the display device. While the gaze of the user wanders, the image section can be correspondingly shifted on the display device, so that the view point that is actually being passed through is always in the center of the display device. The data of the device for the gaze detection can be combined with the data of the device to detect the spatial position and the movement of the head of the user. Thus, the display device can hold a specific point centered if the user moves his head but his gaze, however, remains on the already centered point.

With particular preference, at least one display device can be affixed to the head of the user. It can, for example, be designed as a helmet, a hood, or as glasses. It can thereby be a protective helmet, a respirator hood, safety goggles, a simple frame, or something else on which the display device is affixed or into which the display device is integrated. With particular preference, the display device is designed as a so-called head-mounted display, video glasses, virtual reality glasses, or a virtual reality helmet, which depict images on a screen close to the eyes of the user. The video glasses consist, in particular, of two very small screens that are located in front of the left and right eyes of the user. The display device preferably has, in addition, a device to detect the position and the movement of the head, so that the depicted image section can be adapted as already described above. In one embodiment example of the system in accordance with the invention, the image of the display device is directly projected onto the retina of the user. All aforementioned display devices show a three-dimensional image with particular preference. In this way, a realistic impression is produced during the training.

At least one display device can also be designed as a normal screen, in particular, in the form of an LCD, plasma, LED, or OLED screen, in particular as a commercial TV device, or also as a touch screen with the possibility to select various options. With particular preference, the system comprises at least two display devices, wherein one of them is designed as a system close to the eyes of the user, mentioned above, whereas the other one is present as a normal screen. Logically, the user of the system in accordance with the invention wears the system that is close to his eyes, and onlookers who follow the use of the system look at the normal screen. Also a display device in the form of a projector can be used. All aforementioned display devices can be designed in such a manner that they can give a three-dimensional image or an image with a three-dimensional appearance. This can be carried out, for example, by means of polarization filter technology, a (color)anaglyphic representation, interference technology, shutter technology, autostereoscopy, or by means of another technology.

With particular preference, a first display device displays an image other than the one shown by a second display device. For example, a display device for the user of the system in accordance with the invention displays an image in the already described ego perspective, whereas casual observers see the virtual image of the user during the operation of the tool. Several display devices can also be arranged around the user; they all show a somewhat different image. The image can show, for example, another perspective, depending on where the display device is located. If a display device is located, for example, behind the user, then it shows the image of the user operating the tool from behind. If a display device is located in front of the user, then the display device shows the image of the user from the front. Display devices can be located around the user so as to guarantee a complete all-round visibility, but also only partially, so as to obtain a partial surrounding view. Also, one single continuous display device can be provided, which displays, in sections, different images. Alternatively, all display devices, however, can display the same image.

In a preferred embodiment example of the system in accordance with the invention, a device is located on the tool so as to produce vibrations. This can be, for example, a vibration motor, which makes a part of the tool vibrate. Thus, for example, an operation of the tool can be even better simulated. With particular preference, the device for the production of vibrations can be activated at least as a function of the activation or of the position or the movement of the tool. With particular preference, the device can be activated as a function of all three parameters. The vibration-producing device can, for example, be connected with the device to detect the activation of the tool and to detect whether the tool has been activated. Subsequently, the device for the production of vibrations can be activated automatically and, for example, simulate a running motor or other vibrations that are produced by the operation of the tool. The device for the production of vibrations can also be activated if the image of the tool comes into contact with the virtual processing object. The intensity of the vibration can be dependent on the speed with which the image of the tool strikes the virtual processing object or on other parameters, such as the point of impact, the material of the simulated objects, or something else.

Preferably, the system in accordance with the invention has at least one device to reproduce acoustic signals. The system can thereby consist of, for example, loudspeakers, a system of loudspeakers, or headphones. Also, several similar or different devices can be provided, wherein the user of the system wears headphones and loudspeakers are placed in the vicinity of observers. The loudspeakers can be integrated into a display device or be designed as extra components. The acoustic signals can be stored in the data processing device or a storage unit attached to it, or can be produced by means of synthesizers.

With particular preference, the device for the reproduction of acoustic signals can be actuated at least as a function of the operation or the position or the movement of the tool. Preferably, the operation depends on all three parameters. The device can comprise at least headphones that can be worn by the user of the system in accordance with the invention and/or the device can comprise at least one loudspeaker, which is positioned in the vicinity of the system or somewhat removed from it. The devices can be designed as stereo, 5.1, or as another system. Also, the devices for the reproduction of acoustic signals can be connected to the device for the detection of the operation of the tool and can detect whether the tool has been activated. When the tool is in operation, operating noises of the tool can be automatically emitted, which preferably depend on the intensity of the operation. If, for example, the trigger of a drilling machine is pressed only lightly, then a sound other than the one emitted when it is pressed down completely will be emitted. With a simulation of a coating operation, a softer air sound is emitted with a slight operation of the trigger guard than with a full operation. With a saw, the volume and the speed of change of the noises corresponding to the movements of the saw operated by the user will vary.

A noise can be emitted if the image of the tool or the image of the user comes into contact with the processing object, wherein the type and volume of the noise can depend on the material of the virtual objects, on the speed of the impact, on the point of impact, or on other parameters. Also, background noises that would appear with a real operation of the tool can be emitted by the devices for the reproduction of acoustic signals. For example, compressor noises can be mentioned with coating simulations or forest noises with the simulation of a sawing operation. Different reproduction devices can emit different sounds or sounds with different volumes or other differences. For example, the user of the system can hear the noises with a greater volume than the observers, or he can also perceive fewer noises, however. The device for the reproduction of acoustic signals, however, cannot only emit noises but also spoken words or sentences, for example, give instructions or indicate a malfunction or suboptimal use.

Preferably, the system in accordance with the invention has a device for the release of odorous substances, which can be activated, with particular preference, at least as a function of the operation or the position or the movement of the tool or as a function of at least one state of the user. The odorous substances can correspond to the smells that would appear in reality when operating the corresponding tool. With a simulation of the use of an angle grinder, for example, the smell characteristic for it and/or a metal smell can be automatically released. With sawing simulations, a wood smell can be emitted; with coating simulations, paint and/or solvent smells. The smell can increase with a longer use of the system or it can vary with a changing use. Furthermore, the smell can be released, for example, if the user is not wearing a respirator mask.

Preferably, a change on the tool brings about a change in the image of the tool shown by the at least one display device or a change in the indicated function. For example, the operation of the round/flat spray control of a paint gun leads to a change of the jet of the image of the coating gun. If a round jet is set, then a round jet is emitted from the image of the spray paint gun. If it strikes the processing object, then it is provided with a circular colored surface when the alignment of the gun is vertical. When a flat jet is set, a flat jet is emitted from the spray paint gun image; the colored surface on the object is ellipsoidal. Also, the alignment of the horns of the air nozzle can have an influence. If the horns are vertical relative to one another, then a horizontal flat jet is produced; if they are horizontal relative to one another, then the flat jet is aligned in a vertical manner. With another alignment of the horns, the flat jet is correspondingly inclined. It behaves analogously to this with the air micrometer and the material quantity control, by means of which the air pressure and the volume flow of the coating material can be adjusted. Provision can also be made so that the change of one component of the tool is accompanied by a change of the image of the tool and/or its function. For example, the insertion of another drill into the drilling machine can bring about the display of another drill in the virtual image of the drilling machine. The drilling produced by the drilling machine can also have another diameter or differ in another manner from the drilling with another drill. With a spray paint gun, it is conceivable that the paint cup can be changed on the real tool—for example, if another paint is to be sprayed or if the paint cup is empty. The change can be correspondingly seen on the image of the spray paint gun. Instead of the removed empty cup, a full cup is displayed, or the paint in the cup has been changed. The paint of the jet and of the spray agent striking the object changes accordingly. Such a detection of the change of components can take place, for example, with RFID. A transponder is placed on the changeable component of the tool; it communicates with a reading device, which is connected to the data processing device. If the reading device detects a new RFID signal as a result of a change of the component, then it transmits this signal to the data processing device. It then gives the new component stored under it to the display device, which displays the new component on the tool. The system in accordance with the invention can be designed in such a way that after a longer use of a tool, there is an impairment of the function. For example, a saw can become dull and the virtual processing object cannot be processed as well; the same is true in the case of an angle grinder. With the spray paint gun, the paint can dry up, wherein the jet becomes nonuniform and, with further use, it will contain only air but no more paint. With a continuous use, a uniform emptying of the paint cup can become noticeable. Thus, it is also possible to provide training for the replacement of the components on the tool with the aid of the system.

With particular preference, the image of the tool, the virtual processing object, and the image of the user can be depicted three-dimensionally in three-dimensional surroundings by the at least one display device. In this way, the training, or the simulation, is more realistic. The position of the user in the room can also have an influence on the interaction between the tool and the processing object. If the user, for example, holds his hand in front of the spray paint gun, then the hand of the virtual image also appears in front of the spray paint gun. If the spray paint gun is activated, then the jet exiting from it does not strike or does not strike completely the processing object, but rather, it strikes the hand of the virtual image of the user. The user can also have his virtual image move around in the virtual room and around the processing object, and he can carry out the processing from another position. For example, with the simulation of a coating operation, he can first coat a door, subsequently the engine hood, and then another door. The devices to detect the position and movement, in particular the depth camera or other optical devices, are advantageously designed in such a manner that they follow the user with larger movements, above all, if the user moves around.

In one embodiment example, the tool is a drilling machine, an angle grinder, a hammer, a saw, an axe, a pump, a shovel, or a scythe. In this way, it is possible to simulate many different tools and to provide training for their use. However, tools other than those just mentioned are also conceivable.

With particular preference, however, the tool is a painting device, in particular, a spray paint gun or an airbrush gun, and the virtual processing object is a paintwork surface. The painting device, however, can also be a brush, a paint roller, a pencil, a colored pencil, a spray can, or something similar. Thus, the system in accordance with the invention can also be used for the simulation of creative activities. With the spray paint gun, not only paint but also other coatings such as, for example, clear varnish or other liquids, can be sprayed. The paintwork surface can, for example, be depicted as a vehicle, a vehicle part, a canvas, a piece of paper, a human body, or something similar.

As already mentioned, when the painting device is operated, the display device displays a spray jet that is emitted by the image of the painting device that corresponds to the circumstances in reality.

Preferably, the painting device has a device to adjust the shape of the spray jet, wherein an activation of this device has an influence on the spray jet displayed during the operation of the painting device. This can be adjusted, for example, as a round jet or as a flat jet.

With particular preference, an operation of the painting device brings about a change of the paintwork surface as a function of the position and the movement of the painting device, the adjusted jet shape, and/or other parameters. This means, in particular, that the paintwork surface is provided with paint if the image of the painting device is directed at it in the activated state. This occurs, however, only if the distance between the painting device and the object is small enough. If the user holds the painting device too far from the object, then the paint drops do not strike the object or only isolated ones do so. If the painting device is held at an incline to the object, then more paint is applied on one side than on the other side. If a large material volume flow is set by the material quantity control of the painting device, then the material application on the object takes place more rapidly than if the set material flow is small.

Preferably, the data processing device of the system in accordance with the invention compares the actual position and movement of the tool to a target position and movement and sends a comparison result to the display device for visualization. The system detects, for example, whether the user holds the spray paint gun too close to the paintwork surface, or too far, or if the distance is exactly right. It can also detect whether the user of the spray paint gun moves too slowly or too quickly or at the right speed. During drilling, the system can detect whether the user is holding the drilling machine at an incline to the processing object or at a right angle. With other tools, the parameters that are significant for a successful use are detected. The target parameters can, on the other hand, be stored in the data processing device or a storage unit connected to it so as to be able to compare them to the actual parameters. The result of the comparison between the actual and the target parameters is sent, visualized, to the display devices. They then display the result, for example, in the form of beams, a speedometer, and/or with colored signals. A speedometer can, for example, visualize the correct work speed. For this purpose, it has, for example, two red areas and one green area. The speedometer needle is dependent on the work speed. If the movements of the user are too slow, then the speedometer needle can stand in a left and/or lower red area. If the speed is too high, then it can stand in a right and/or upper red area. If the work speed is suitable, the speedometer needle stands in the middle, in the green area. The distance between the spray paint gun and the object can be visualized by means of beams, which can be colored green, yellow, or red. Of course, other colors can always also be used.

Preferably, the data processing device of the system in accordance with the invention compares the actual position and movement of the tool to a target position and movement and at least one device for the reproduction of acoustic signals emits an acoustic signal as a function of the comparison result. This acoustic signal can, for example, be a noise that is emitted with a wrong movement or another noise that is emitted with a right movement. The sounds can also be words and sentences that can indicate a malfunction or errors in use to the user and/or they can provide improvement suggestions. In this way, an audiovisual training system can be created.

Preferably, the data processing device evaluates results for the use of the tool and transmits them to at least one display device. They can be, for example, results from the just mentioned target-actual comparison. Thus, during the simulation, the system can indicate how long the tool was correctly held and how long it was incorrectly held. From this, a ratio and an evaluation can be calculated. However, the work speed, the use which has already taken place, or something similar can also be indicated. Methods for the calculation of a work quality and/or efficiency can also be stored in the data processing device or a storage medium attached to it; they can collect and evaluate the information regarding the operation of the tool. When using a hammer, for example, the number of blows needed can be counted and an evaluation can be carried out, taking into consideration the time needed. When simulating a coating process, for example, the minimum or maximum layer thickness, the average thickness, or the consumed coating material can be displayed, and the uniformity of the layer or the work efficiency, taking into consideration the time required, can be evaluated and displayed. The results can be displayed both during as well as after the simulation.

With particular preference, several of the just mentioned results can be stored in the data processing device, compared, and depicted as a ranking list by means of the at least one display device. For example, the work efficiency or the work quality of several uses, in particular, several users, can be stored, compared, and displayed as a rank order. The system can be designed in such a manner that the users can enter in their names.

Preferably, a menu can be displayed on the at least one display device; by means of the menu, the shape or the characteristics of the image of the tool, the image of the user, or the shape or the characteristics of the virtual processing object can be changed. The user, for example, can select which tool he would like to operate, whereupon the simulation is set up for this tool. Something similar can take place if the user selects another model of a tool or another component. For example, the user can select a drilling machine as the tool—the model X from the manufacturer Y and a drill with a 5-mm diameter—or a spray paint gun from the manufacturer A, model B, with a flow cup and a blue color. Also, the processing object can be selected, for example, whether it is made of wood or metal and whether it is a mud guard or a car door. The system can also be designed in such a way that the user can select various images, so-called avatars, that follow his movements on the display device and virtually operate the tool. Therefore, simulations for different tools, models, avatars, and other things can be stored in the system.

Preferably, the menu is to be opened by activating an icon. This icon is to be seen on at least one display device and can logically be provided with the designation “Menu.” When the icon is activated, the menu described above appears for the selection of various parameters. With particular preference, the menus can be opened by the tool and menu items can be selected by the tool. For the purpose, the user points to the at least one icon displayed by at least one display device and activates the tool. The icon can be displayed on the surface of the representation of the display device, or in the virtual space which the display device displays. In the latter case, the icon of the image of the user can be activated by the image of the tool. However, the icon can also be displayed on a touch screen and can be activated by pressing the touch screen.

In a preferred embodiment example of the system in accordance with the invention, a malfunction of the tool can be simulated. This can be a part of the normal simulation process or can be provided as an extra mode. In the first case, the malfunction can, for example, appear suddenly. Thus, for example, the capacity of a drilling machine or a saw can decline or a spray paint gun can spray asymmetrically. The extra mode can be selectable in a manner alternative to the normal simulation. Various malfunctions can be represented or simulated. For example, the spray pattern of an unsatisfactorily functioning spray paint gun can be displayed, or the operation of an unsatisfactorily functioning spray paint gun can be simulated.

With particular preference, selection possibilities for the identification of the malfunction or its elimination can be displayed on at least one display device. With the drilling machine, for example, the selection possibilities “Increase rpm,” “Decrease rpm,” “Tighten drill,” “Change drill,” or something else can be depicted. With the spray paint gun, the selection possibilities can be as follows: “Clean air holes,” “Test paint nozzle for damage,” “Lower input pressure,” “Increase input pressure,” or something similar. The user can select the problem that is pertinent in his opinion, or he can select the possible solution. This can be done, again, by aiming the tool at the possible solution and selecting by activating the tool, by pressing on a touch screen, or with the aid of some other input device. Preferably, a target selection is then compared to the actual selection of the user and the result of the comparison is indicated, visualized, by at least one display device. For example, the selection field is illuminated green with the correct answer, whereas with the wrong answer, it is colored red. This can be accompanied by an acoustic signal, for example, a sound, or a message. The system in accordance with the invention can be equipped in such a way that the simulated malfunction of the tool can be eliminated when there is an agreement between the target selection and the actual selection of the user. This means that with a correct answer, the tool is once again functioning satisfactorily.

Preferably, the system in accordance with the invention has a device for the recording of the simulation or the image indicated by at least one display device. This means that the images indicated by the display unit are stored and can be played after the conclusion of the simulation. In this way, the user can look at his work and, eventually, any errors can be analyzed.

With particular preference, the system in accordance with the invention is located in a cabin. In this way, the user can concentrate better on his activity and the systems to detect the spatial position and the movement of the user and the tool can work without interruption if there are no persons other than the user in their detection range.

Preferably, the system in accordance with the invention has at least one camera to detect at least one part of the surroundings of the system. The camera can, for example, be directed at the bystanders who are observing the simulation. The detected images can be integrated into the simulation in a time-staggered or simultaneous manner. For example, a window can be integrated in a virtual coating cabin in which the virtual coating process is carried out; the detected images are displayed in the area of the window. In this way, the impression is produced that the bystanders are observing the virtual painter while he is working.

Preferably, the system has a device to examine the safety precautions. The device can, for example, see whether the user is wearing protective clothing, whether movable or moved parts of the tool are fixed, or whether other criteria have been fulfilled. In order to be able to test a sufficient fixing of the parts, it is possible, for example, to provide a pressure sensor that determines whether a sufficient clamping force is acting on the part. Thus, for example, it can be ensured that a drill was clamped with sufficient firmness into a drilling machine or a saw blade, into a saw. The wearing of protective clothing can, for example, be examined by radio, for example, RFID. An absence of the signal can indicate that the protective clothing has not been worn. If the absence of a safety precaution is determined, then this is indicated by at least one display device. The system can be designed in such a way that a simulation is not possible if all safety precautions are not being observed.

With regard to the method in accordance with the invention, the statements above are analogously valid.

The invention is explained in more detail below with the aid of drawings. The figures thereby show the following:

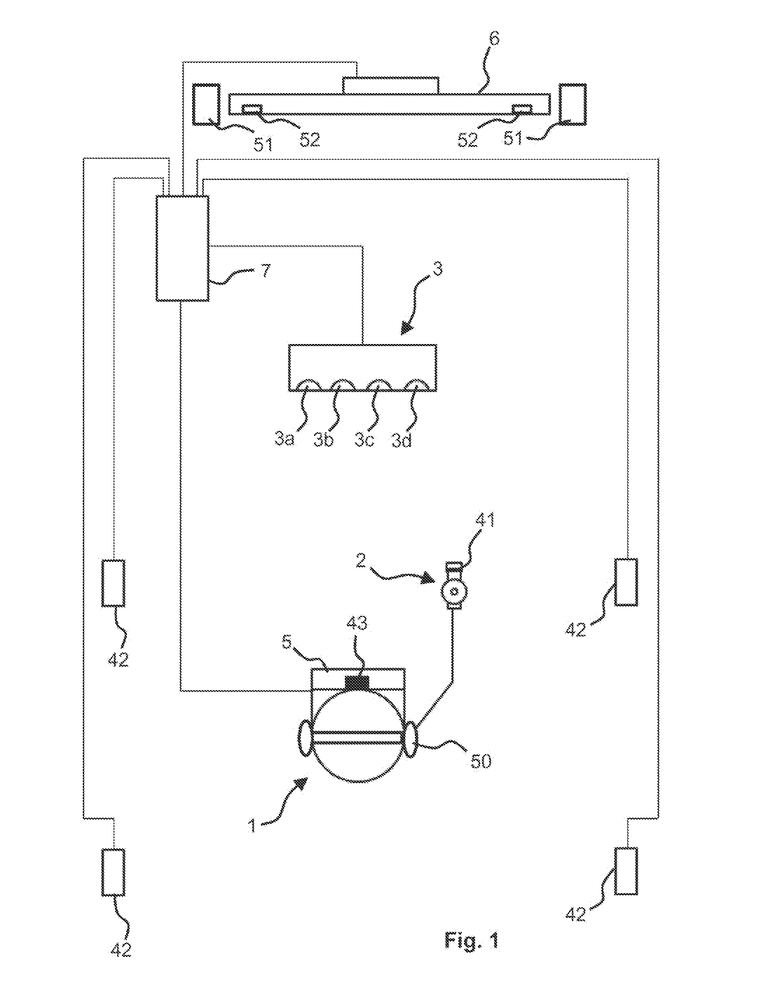

FIG. 1, a top view of the fundamental structure of an embodiment example of the system; and

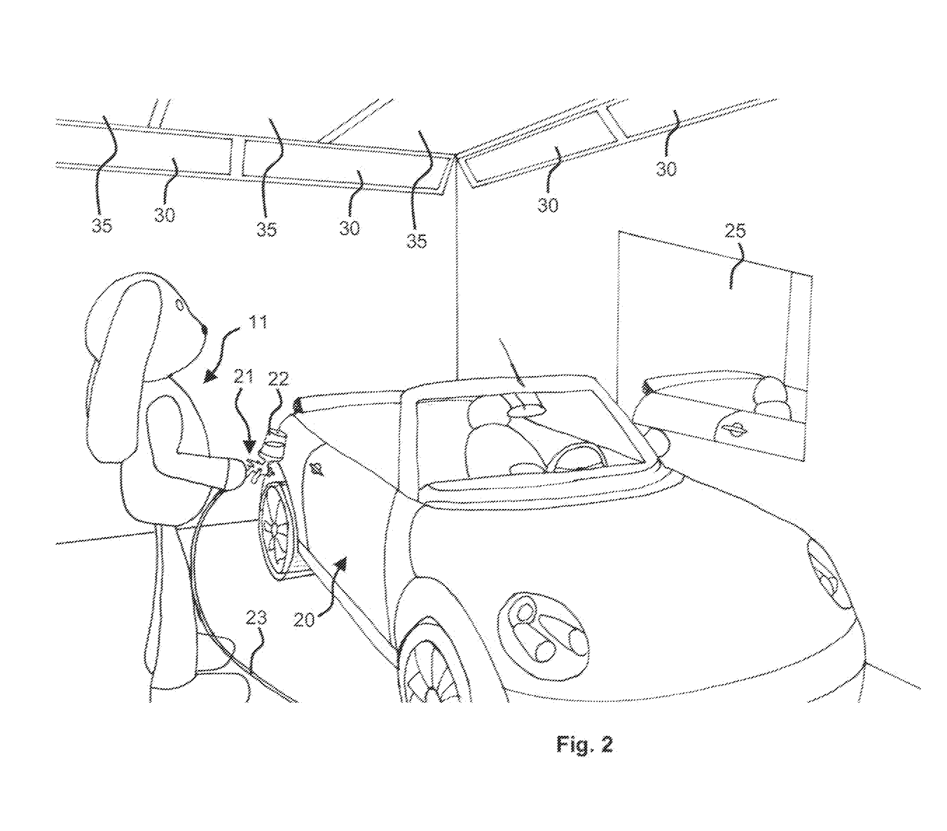

FIG. 2, an example of the representation of a simulated coating process.

FIG. 1 shows a top view of the fundamental structure of an embodiment example of the system in accordance with the invention. In the case under consideration, user 1 simulates a coating process using a spray paint gun 2. The position and the movements of the user 1 are detected here by means of a depth camera 3. It essentially consists of two infrared sensors 3a, 3d, an illuminating unit 3b, and a color camera 3c. With this structure, it is possible to detect the position and the movement of an object in three-dimensional space. The data detected by the depth camera 3 are transmitted to the data processing device 7, which is, for practical purposes, designed as a PC. By the installation of the corresponding software, almost any PC can be used with the system in accordance with the invention. However, the use of other computers, in particular, tablet PCs, is also conceivable.

The spray paint gun 2 has two additional position and movement detection devices, which are advantageously designed as a radio transmitter 41. This radio transmitter 41 transmits radio signals to four radio receivers 42 in the case under consideration. In this way, it is possible to detect the position and the movement of the spray paint gun 2 in the x, y, and z directions. By means of at least one additional sensor, it is also possible to detect angles and thus slopes of the spray paint gun 2. The detected position and movement data of the spray paint gun 2 are likewise sent to the data processing device 7.

The position and movement data are converted in movable three-dimensional objects by 3-D animation methods in the data processing device 7 and sent to the display devices 5, 6. In the case under consideration, the display device 5 is designed as a head-mounted display 5, which is carried by the user of the system. In this way, it essentially sees only the image of the display device 5 and is not distracted by disturbances in the vicinity. By the near-to-eye arrangement of the screens of the head-mounted display 5, a very good 3-D impression is produced, which allows the training situation to appear very realistically. The head-mounted display shows the virtual coating process from the view of the image of the user. For example, he sees the virtual processing object and a part of the surroundings, the image of the tool and the part of his virtual image that is located in his field of vision, for example, the arm that operates the tool. The head-mounted display has an additional radio transmitter 43, which sends radio signals to the radio receivers 42 or to other radio receivers. In this way, a determination of the position of the head of the user 1 is made possible. The display device 6, present here in the form of a flat screen, is located outside the cabin in which the simulation system is located. It is meant for bystanders who want to follow the virtual coating process. In the example under consideration, three different devices for the reproduction of acoustic signals are present, namely, headphones 50, which are worn by the user 1, two loudspeakers 51 integrated into the flat screen, and two additional loudspeakers 52.

The components shown in FIG. 1 and their arrangement are, of course, shown only by way of example. More or fewer or other components can also be provided. The data and signal transmission between the components can take place both with and without cables, for example, via radio, for example, by means of Bluetooth.

FIG. 2 shows an example of a representation of the display device 6 from FIG. 1. In the case under consideration, the coating of a PKW 20 or a part thereof is simulated in a coating cabin. An avatar 11, that is, a virtual image of the user of the simulation system, present here in the shape of a fantasy figure, holds in his hand a spray paint gun 21 with a paint cup 22, partially filled with paint, and a compressed air hose 23. One can see that the surface of the paint is parallel to the ground. When the gun is moved, the surface is always aligned as is also the case in reality. There is a mirror 25 opposite the avatar 11. The purpose of this is that the user of the system, who sees the use from the view of his avatar 11, can also see his avatar 11 from the front and thus can observe himself when using the tool—in the case under consideration, when coating with a spray paint gun.

As already described, the avatar 11 is simultaneously moved by the movements of the user 1 of the system in accordance with the invention. If the user 1 lifts his left leg, then the avatar 11 lifts his left leg simultaneously. If the user 1 moves his head, then the avatar 11 does the same. If the user 1 activates the tool 2 or the controller that he, in reality, holds in his hand, then the described device to detect the operation of the tool 2 records this operation and sends the information to the data processing device 7. The display devices 5, 6 thereupon show an image of the tool 2 in an activated state. In the case under consideration, a spray jet would exit from the spray paint gun 21, which can appear different, depending on the selected setting, and the paint has the color found in the paint cup 22. If the spray paint gun 21 is at a suitable distance from the processing object, here, the PKW (car) 20, then the area in front of the spray paint gun which is struck by the spray jet is colored in accordance with the paint in the paint cup 22. This area spreads if the user 1 and thus also his avatar 11, or the spray paint gun 2 or 21, moves. The coating takes place correctly with uniform back and forth movements, left and right, until the desired surface characteristics, for example, the layer thickness and appearance, are attained. The compression air hose 23 follows the movements of the spray paint gun.

The virtual coating cabin can be equipped with illumination 30, return or supply filters 35, and other accessories, such as compressed air filters, compressors, gun stands, paint containers, or something else.

In conclusion, reference is made to the fact that the described embodiment example describes only a limited selection of embodiment possibilities and thus does not represent a limitation of the invention under consideration.

1-100. (canceled)

101. System for simulating the operation of a nonmedical tool, having at least one device to detect the spatial position and the movement of a user, a data processing device, and at least one display device, which displays a virtual processing object, wherein the data of the device to detect the spatial position and the movement of a user are sent to the data processing device and forwarded to at least one display device, which displays an image of the user or a part of the user and an image of the tool, wherein the positions and the movements of the images are displayed as a function of the data of the device to detect the spatial position and the movement of the user relative to the virtual processing object.

102. System according to claim 101, wherein the tool has at least one sensor, the at least one sensor is designed as a slope sensor, a gravity sensor, an acceleration sensor or an angle sensor.

103. System according to claim 101, wherein at least one device is provided to detect the spatial position and the movement of a body part of a user.

104. System according to claim 103, wherein at least one device to detect the spatial position and the movement of a body part of the user is located on the head of the user.

105. System according to claim 103, wherein the display of at least one display device changes as a function of the position and the movement of the head of the user.

106. System according to claim 101, wherein at least one device for gaze detection is provided.

107. System according to claim 106, wherein the display of at least one display device is changed as a function of the line of vision of the user.

108. System according to claim 101, wherein a device to produce vibrations is located on the tool, the device to produce vibrations can be activated at least as a function of the operation or the position or the movement of the tool.

109. System according to claim 101, wherein the system has at least one device to reproduce acoustic signals, the at least one device for the reproduction of acoustic signals is activated at least as a function of the operation or the position or the movement of the tool.

110. System according to claim 101, wherein the system has a device for the release of odorous substances, the device to release odorous substances can be activated at least as a function of the operation or the position or the movement of the tool or as a function of at least one state of the user.

111. System according to claim 101, wherein the tool is a painting device, in particular, a spray paint gun or an airbrush gun, and that the virtual processing object is a paintwork surface.

112. System according to claim 111, wherein with the activated painting device, the at least one display device displays a spray jet that is emitted from the image of the painting device.

113. System according to claim 111, wherein the painting device has a device to adjust the shape of the spray jet and that an operation of this device has an influence on the spray jet displayed during the operation of the painting device.

114. System according to claim 111, wherein an operation of the painting device brings about a change of the paintwork surface as a function of the position and the movement of the painting device, the set spray shape, or other parameters.

115. Method for simulating the operation of a tool, comprising at least the following steps:
a) detection of the spatial position and the movement of a user by a first device;
b) transmission of the detected data for the position and the movement of the user to a data processing device, processing of the data, and forwarding to at least one display device;
c) display of an image of the user or a part of the user and an image of the tool by the at least one display device in accordance with the data for the position and the movement of the user relative to a virtual processing object displayed by the display device.

116. Method according to claim 115, wherein at least one slope sensor, gravity sensor, acceleration sensor, or angle sensor, located on the tool, sends data to the data processing device.

117. Method according to claim 115, wherein the spatial position and the movement of a body part of the user are detected.

118. Method according to claim 117, wherein the spatial position and the movement of the head of the user are detected.

119. Method according to claim 118, wherein the display of at least one display device changes as a function of the position and the movement of the head of the user.

120. Method according to claim 115, wherein the line of vision of the user is detected and in that the display of at least one display device changes as a function of the line of vision of the user.

121. Method according to claim 115, wherein an application of paint or a coating on a coating surface is simulated by a coating device, in particular, a spray paint gun or an airbrush gun.

122. Method according to claim 121, wherein when operating the coating device, the at least one display device displays a spray jet, which is emitted by the image of the coating device.

123. Method according to claim 121, wherein the coating device has a device for the adjustment of the shape of the spray jet and wherein the displayed spray jet changes if this device is or was activated.

124. Method according to claim 121, wherein the paintwork surface is changed as a function of the position and the movement of the painting device, of the jet shape set, and/or other parameters if the painting device is activated.
